(19) United States
(12) Patent Application Publication
(10) Pub. No.: US 2026/0319729 A1
(43) Pub. Date: Oct. 15, 2026

(54) DISPLAY CONTROL SYSTEM

(71) Applicant: Panasonic Intellectual Property Management Co, Ltd., Osaka (JP)

(72) Inventors: Masamitsu MURASE, Kyoto (JP); Ken HATSUDA, Kyoto (JP); Riku MATSUMOTO, Hyogo (JP)

(21) Appl. No.: 19/463,411

(22) Filed: Jan. 29, 2026

Related U.S. Application Data
(63) Continuation of application No. PCT/JP2024/015004, filed on Apr. 15, 2024.

(51) Int. Cl. G06F 3/14

(52) U.S. Cl. CPC G06F 3/1454

(57) ABSTRACT

A display control system includes an electronic device having a controller that generates virtual extended screen data based on detection of a wired or wireless network or device connection, at least one external display terminals each having a display and displaying a virtual extended screen on the display based on the virtual extended screen data, and a relay device connected to the electronic device and the at least one external display terminals wirelessly or by wire, the relay device receiving the virtual extended screen data from the electronic device and transmitting the virtual extended screen data to the at least one external display terminals.

### BACKGROUND

### Technical Field

The present disclosure relates to a display control system.

### Background Art

It is known that usability can be improved by connecting an external display to an electronic device such as a laptop PC to expand the desktop screen of the laptop PC.

For example, JP2010-267142A discloses an information processing device that, when it detects that an external display has been connected to an external display connection terminal, with one of plural virtual desktops being displayed on an LCD, reads the virtual desktop stored with the external display set as the display destination device from the HDD and displays it on the actual display screen of the external display.

The information processing apparatus described in JP2010-267142A still has room for improvement in terms of expanding the desktop screen based on the connection of a device other than an external display or based on a network connection.

### SUMMARY

The present disclosure provides a display control system that can extend the desktop screen based on a device or network connection.

An aspect of the present disclosure provides a display control system. The display control system includes an electronic device having a controller that generates virtual extended screen data based on detection of a wired or wireless network or device connection; at least one external display terminals each having a display and displaying a virtual extended screen on the display based on the virtual extended screen data; and a relay device connected to the electronic device and the at least one external display terminals wirelessly or by wire, the relay device receiving the virtual extended screen data from the electronic device and transmitting the virtual extended screen data to the at least one external display terminals, wherein the relay device acquires, from the at least one external display terminals, display information related to at least one of size or resolution of the display of the at least one external display terminals, and wherein the relay device modifies the virtual extended screen data based on the display information and transmits the modified data to the at least one external display terminals.

According to the present disclosure, a display control system can be provided that can extend the desktop screen based on a device or network connection.

### BRIEF DESCRIPTION OF DRAWINGS

FIG. 1 is a block diagram schematically showing a configuration of a display control system according to a first embodiment;

FIG. 2 is a schematic diagram schematically showing the configuration the display control system of FIG. 1;

FIG. 3 is a flowchart for explaining the operation of the display control system;

FIG. 4 is a block diagram schematically showing a configuration of a display control system according to a first variant of the first embodiment;

FIG. 5 is a schematic diagram schematically showing the configuration the display control system of FIG. 4;

FIG. 6 is a block diagram schematically showing a display control system according to a second embodiment;

FIG. 7 is a block diagram schematically showing a display control system according to a third embodiment;

FIG. 8 is a block diagram schematically showing a display control system according to a fourth embodiment;

FIG. 9 is a block diagram schematically showing a display control system according to a first variant of the fourth embodiment;

FIG. 10 is a block diagram schematically showing a display control system according to a fifth embodiment; and

FIG. 11 is a block diagram schematically showing a display control system according to a first variant of the fifth embodiment.

### DETAILED DESCRIPTION

### Background to the Present Disclosure

Portable electronic devices such as laptop PCs are sometimes used in automobiles. At this time, there is a demand for using the display of an in-vehicle device such as a car navigation system or a tablet device as an extended display for the laptop PC.

However, it is difficult to have the display of an external device such a car navigation system or tablet device recognized as an extended display simply by connecting it to a laptop PC, which requires the user to perform complicated setup work, and there is a need for further improvements in user convenience.

Thus, the present inventors have considered implementing automatic recognition of the display of an external device as an extended display of a laptop PC based on detection of the device or network connection, and have arrived at the following invention.

### First Embodiment

### [Overall Configuration]

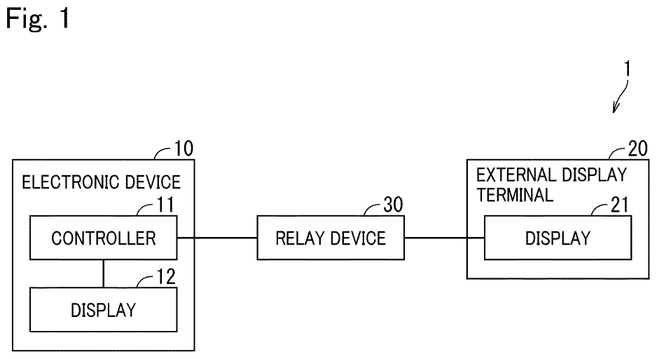

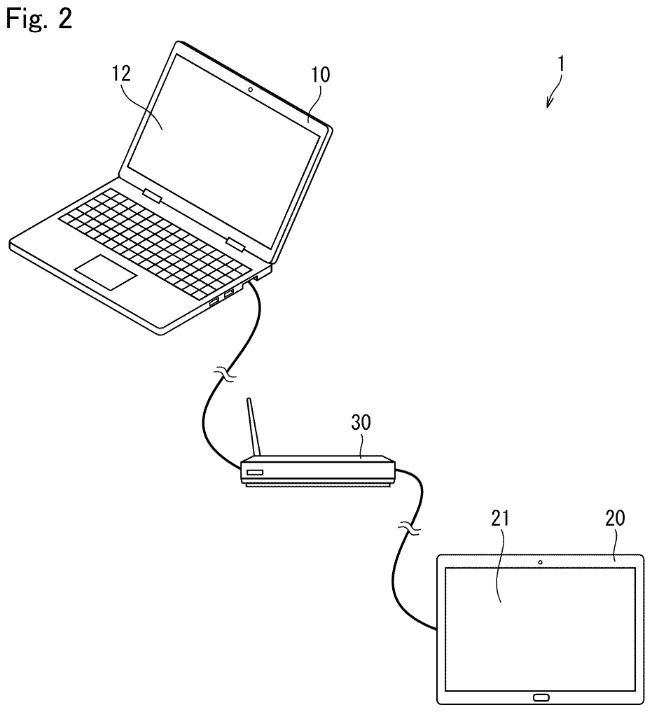

FIG. 1 is a block diagram schematically showing a configuration of a display control system 1 according to a first embodiment. FIG. 2 is a schematic diagram showing the configuration of the display control system 1 of FIG. 1.

As shown in FIGS. 1 and 2, the display control system 1 includes an electronic device 10, an external display terminal 20, and a relay device 30 connected to the electronic device 10 and the external display terminal 20. In the display control system 1, the electronic device 10 and the external display terminal 20 are connected via the relay device 30, and the external display terminal 20 can be used as an extended display for the electronic device 10.

The electronic device 10 is a portable terminal device such as a laptop PC or a tablet device having a display 12 such as a liquid crystal display or an OLED (Organic Light Emitting Diode) display. In this embodiment, as shown in FIG. 2, the case will be descried as an example where the electronic device 10 is a laptop PC.

When it is detected that a device or a network has been connected to electronic device 10, virtual extended screen data is generated in the electronic device 10 and transmitted to the external display terminal 20 connected to the electronic device 10 via the device or the network. By transmitting the virtual extended screen data to the external display terminal 20, the external display terminal 20 can be used as an extended display for the electronic device 10.

The extended display of the electronic device 10 refers to a display that can be used by extending the screen area of the display 12 of the electronic device 10. In the present embodiment, for example, a display of a car navigation system, a tablet device, or a smartphone can be used as the extended area of the display 12 of the electronic device 10.

The virtual extended screen data is data that constitutes a screen image of the extended screen area of the display 12 of the electronic device 10. In the present embodiment, when the electronic device 10 detects a wired or wireless connection to an external device or a network connection, the virtual extended screen data is generated in the electronic device 10.

The electronic device 10 is an electronic device such as a laptop PC or a tablet device, and includes, for example, a controller 11 and the display 12. The controller 11 is a processor for controlling the electronic device 10, and is configured, for example, by a processor that implements predetermined functions by executing programs stored in an internal storage. The controller 11 is not limited to a processor that performs predetermined functions through cooperation between hardware and software, but may also be a hardware circuit designed to implement the predetermined functions. In other words, the controller 11 can be configured by various processors such as a microcomputer, a CPU, an MPU, a GPU, a DSP, an FPGA, an ASIC, etc. In this embodiment, the controller 11 generates virtual extended screen data based on detection of a wired or wireless network or device connection.

The external display terminal 20 is a device having a display 21. The external display terminal 20 may be, for example, a device including a car navigation system, a tablet device, or a smartphone, and may be a terminal device that is not normally used as an external display for an electronic device. The external display terminal 20 displays a virtual extended screen on the display 21 based on virtual extended screen data. The virtual extended screen is a screen that extends the display 12 of the electronic device 10 and that is displayed on the display 21 of the external display terminal 20. By displaying the virtual extended screen on the display 21 of the external display terminal 20, the display 12 of the electronic device 10 can be extended to the display 21 of the external display terminal 20, resulting in a larger display. In order to distinguish between the display 12 of the electronic device 10 and the display 21 of the external display terminal 20, in this specification, the display 12 of the electronic device 10 will be referred to as the first display 12, while the display 21 of the external display terminal 20 will be referred to as the second display 21.

The second display 21 may be, for example, a touch panel display. In this case, input on the touch panel is transmitted to the electronic device 10 via the relay device 30.

The relay device 30 is a device that is connected to the electronic device 10 and the external display terminal 20, to receive virtual extended screen data generated by the electronic device 10 and transmit the received virtual extended screen data to the external display terminal 20. The electronic device 10 and the relay device 30 are connected via a wired or wireless connection. Similarly, the external display terminal 20 and the relay device 30 are connected via a wired or wireless connection. FIG. 2 shows an example in which the relay device 30 and the electronic device 10 are connected via a wired connection, and the relay device 30 and the external display terminal 20 are connected via a wired connection. The relay device 30 is configured, for example, by a device including a processor that implements a predetermined function by executing a program stored in an internal storage. The relay device 30 is not limited to a device that performs a predetermined function through cooperation between hardware and software, but may be a hardware circuit designed to implement the predetermined function. In other words, the relay device 30 can be configured by a device including various processors such as a microcomputer, a CPU, an MPU, a GPU, a DSP, an FPGA, an ASIC, etc.

As described above, in the display control system 1 of this embodiment, the controller 11 of the electronic device 10 generates virtual extended screen data when it detects a connection between the electronic device 10 and the relay device 30. The generated virtual extended screen data is transmitted to the external display terminal 20 via the relay device 30, and the virtual extended screen is displayed on the external display terminal 20. In other words, in the display control system 1 of this embodiment, the detection of a connection between the electronic device 10 and the relay device 30 serves as a trigger to enable the electronic device 10 to use the second display 21 of the external display terminal 20 as an extended display.

### [Operation]

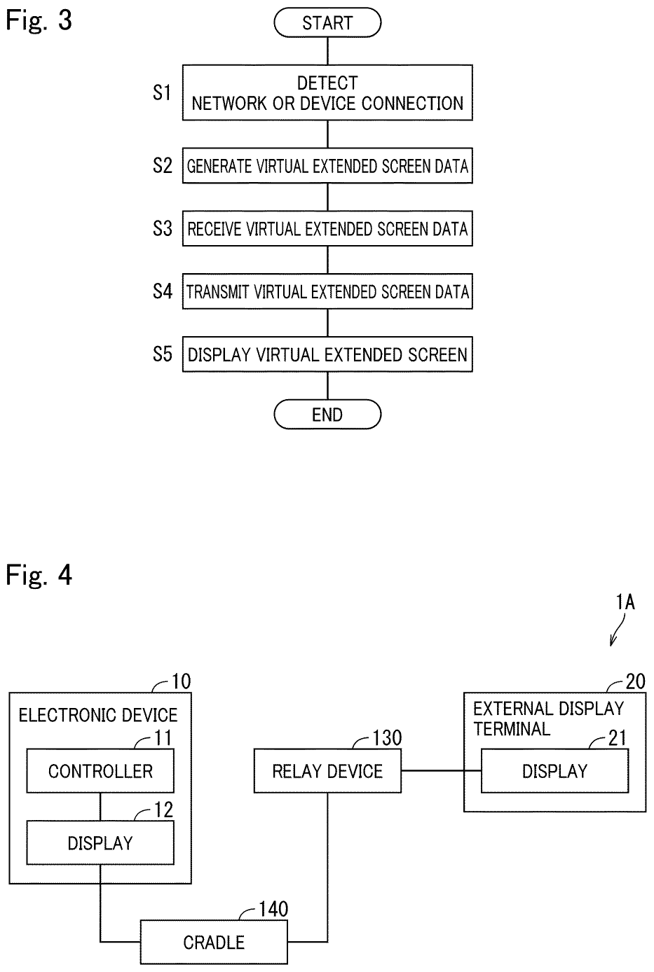

The operation of the display control system 1 will be described with reference to FIG. 3. FIG. 3 is a flowchart for explaining the operation of the display control system 1.

In step S1, the controller 11 of the electronic device 10 detects a network or device connection. Specifically, the controller 11 detects that the electronic device 10 has been connected to a network or that another electronic device has been connected to the electronic device 10. In this embodiment, the controller 11 detects an electrical connection between the electronic device 10 and the relay device 30 as the another electronic device.

When the controller 11 detects the connection between the electronic device 10 and the relay device 30, the controller 11 generates virtual extended screen data in step S2. The controller 11 transmits the generated virtual extended screen data to the relay device 30.

When the controller 11 transmits the virtual extended screen data to the relay device 30, in step S3, the relay device 30 receives the virtual extended screen data generated by the controller 11. Next, in step S4, the relay device 30 transmits the received virtual extended screen data to the external display terminal 20.

When the relay device 30 transmits the virtual extended screen data to the external display terminal 20, in step S5, the external display terminal 20 displays the virtual extended screen on the second display 21 based on the virtual extended screen data, to end the processing.

### [Effects]

According to the above embodiment, the following effects can be achieved.

The display control system 1 includes the electronic device 10, the external display terminal 20, and the relay device 30. The electronic device 10 has the controller 11 that generates virtual extended screen data based on detection of a wired or wireless network or device connection. The external display terminal 20 has the display 21 and displays a virtual extended screen on the display 21 based on the virtual extended screen data. The relay device 30 is connected to the electronic device 10 and the external display terminal 20 wirelessly or wiredly, receives the virtual extended screen data from the electronic device 10, and transmits the virtual extended screen data to the external display terminal 20.

With this configuration, it is possible to provide a display control system that can extend a desktop screen based on a device connection. The controller 11 of the electronic device 10 generates virtual extended screen data when detecting a connection with the relay device 30. The relay device 30 receives the virtual extended screen data from the electronic device 10 and transmits it to the external display terminal 20. The external display terminal 20 displays a virtual extended screen on the display 21 based on the virtual extended screen data. In this way, detection of a connection between the electronic device 10 and the relay device 30 can be used as a trigger to display a virtual extended screen that extends the desktop screen.

The external display terminal 20 includes at least one of a car navigation system, a tablet device, or a smartphone.

Such a configuration enables the display of the terminal device, which not normally used as an external display, to be used as an extended screen.

In the above embodiment, an example has been described in which the display control system 1 includes one external display terminal 20, but this is not limitative. The display control system 1 may include two or more external display terminals 20. By connecting a plurality of external display terminals 20, the extendability of the electronic device 10 can be improved.

In the above embodiment, an example has been described in which the electronic device 10 and the relay device 30 are connected by wire, but this is not limitative. The electronic device 10 and the relay device 30 may be connected wirelessly. The electronic device 10 and the relay device 30 may also be connected via another device.

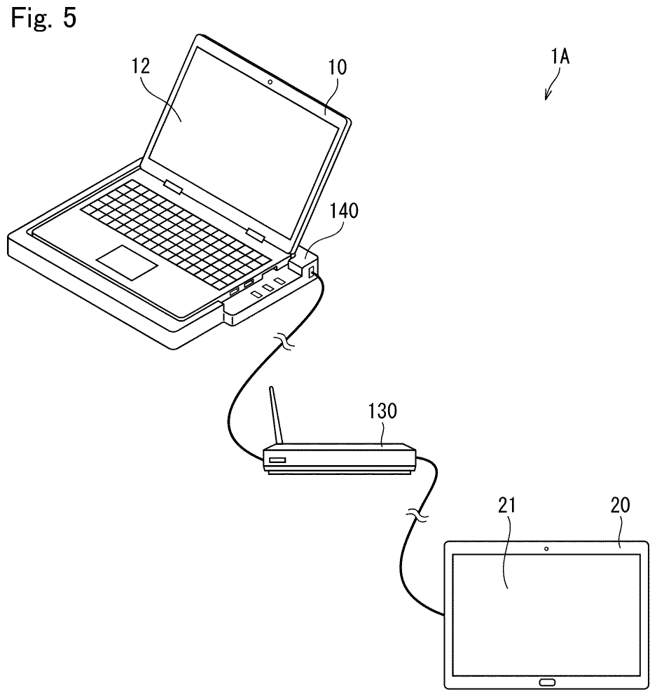

FIG. 4 is a block diagram schematically showing a configuration of a display control system 1A according to a first variant of the first embodiment. FIG. 5 is a schematic diagram schematically showing the configuration of the display control system 1A of FIG. 4.

As shown in FIGS. 4 and 5, in the display control system 1A, a relay device 130 is connected to a cradle 140 connectable to the electronic device 10. In the display control system 1A, the electronic device 10 and the relay device 130 are connected via the cradle 140. The relay device 130 and the cradle 140 are connected in advance, and when the electronic device 10 is connected to the cradle 140, the controller 11 can detect the connection between the electronic device 10 and the relay device 130 via the cradle 140. In this case, the controller 11 of the electronic device 10 can generate virtual extended screen data based on the detection of the connection between the electronic device 10 and the cradle 140.

The term “cradle” refers to a device that is connected to an electronic device such as a laptop PC to charge the electronic device or extend the input/output terminals of the electronic device and that is also called a dock, docking station or port replicator. For example, in the case of using the electronic device 10 in a vehicle, connecting the electronic device 10 to an in-vehicle cradle 140 allows the electronic device 10 to be fixed in place inside the vehicle. For example, in the case where the external display terminal 20 connected to the relay device 130 is a car navigation system, the display (second display 21) of the car navigation system can be used as an extended display for the electronic device 10.

### Second Embodiment

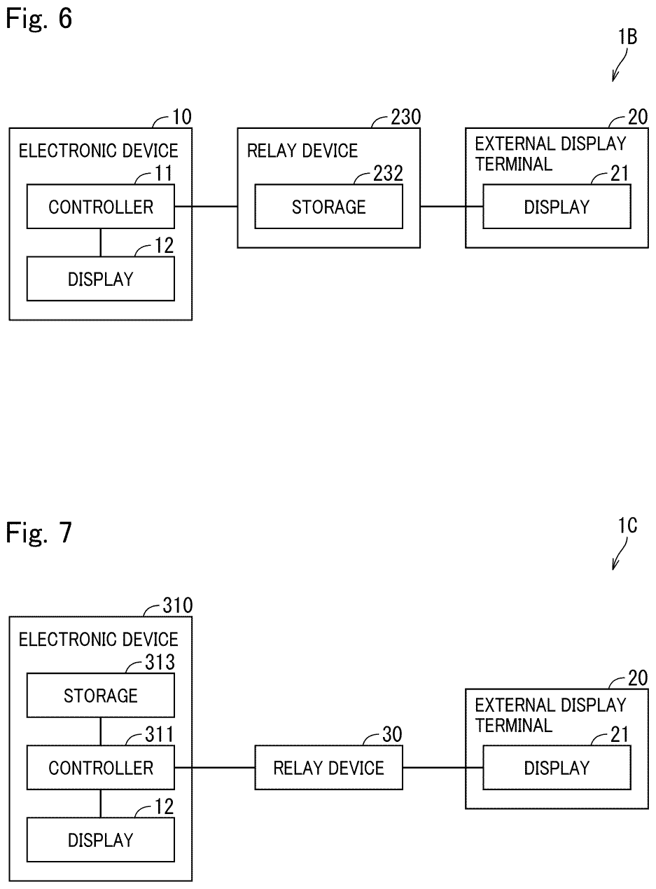

A second embodiment will be described with reference to FIG. 6. In the second embodiment, the same or equivalent components as those in the first embodiment will be denoted and described using the same reference numerals. In the second embodiment, descriptions overlapping with those in the first embodiment will be omitted.

FIG. 6 is a block diagram schematically showing a display control system 1B according to the second embodiment. As shown in FIG. 6, the second embodiment differs from the first embodiment in that a relay device 230 includes a storage 232. The second embodiment also differs from the first embodiment in that the relay device 230 acquires display information and stores it in the storage 232. The other configurations of the display control system 1B are similar to those of the display control system 1 described in the first embodiment, and therefore will not be described again.

As shown in FIG. 6, the relay device 230 has the storage 232. The storage 232 is a storage that stores display information of the external display terminal 20, which will be described later. The storage 232 is configured, for example, by a semiconductor storage such as a flash memory or a solid-state drive (SSD), a magnetic storage such as a hard disk drive (HDD), or a volatile memory such as an SRAM or DRAM.

The relay device 230 can acquire display information related to at least one of the size and resolution of the second display 21 from the external display terminal 20 and store the acquired display information in the storage 232 of the relay device 230. The display information is information including, for example, at least one of the resolution, aspect ratio, or number of pixels of the second display 21. The relay device 230 modifies the virtual extended screen data received from the electronic device 10 based on the display information stored in the storage 232 and transmits the modified data to the external display terminal 20. Modification based on the display information includes, for example, enlarging or reducing the virtual extended screen data generated by the controller 11 of the electronic device 10 to match the size or resolution of the second display 21 based on the display information.

For example, when the relay device 230 and the external display terminal 20 are connected, the display information is transmitted from the external display terminal 20 to the relay device 230 and stored in the storage 232. Alternatively, the relay device 230 may periodically receive the display information from the external display terminal 20.

### [Effects]

According to the above embodiment, the following effects can be achieved.

The relay device 230 acquires display information related to at least one of the size or resolution of the display 21 from the external display terminal 20. The relay device 230 modifies the virtual extended screen data based on the display information and transmits the modified data to the external display terminal 20.

By virtue of this configuration, even if the external display terminal 20 connected to the relay device 230 is changed and the size or resolution of the second display 21 changes, the virtual extended screen data can be adapted to the size or resolution of the second display 21 of the external display terminal 20 connected to the relay device 30.

### Third Embodiment

A third embodiment will be described with reference to FIG. 7. In the third embodiment, the same or equivalent components as those in the first embodiment will be denoted and described using the same reference numerals. In the third embodiment, descriptions overlapping with those in the first embodiment will be omitted.

FIG. 7 is a block diagram schematically showing a display control system 1C according to the third embodiment. As shown in FIG. 7, the third embodiment differs from the second embodiment in that an electronic device 310 has a storage 313 instead of the relay device 30. The other configurations of the display control system 1C are similar to those of the display control system 1 described in the first embodiment, and therefore will not be described again.

In this embodiment, as shown in FIG. 7, the electronic device 310 includes the storage 313. The storage 313 stores display information related to at least one of the size or resolution of the display 21 of the external display terminal 20. The display information includes, for example, at least one of the resolution, aspect ratio, or number of pixels of the second display 21. The display information may be stored in advance in the storage 313 by, for example, a user input. Alternatively, when a connection between the electronic device 310 and the relay device 30 is detected, a controller 311 may acquire the display information from the external display terminal 20 via the relay device 30. In the case where plural external display terminals 20 are connected to the relay device 330, the storage 313 can store display information corresponding to each of the plural external display terminals 20.

The controller 311 of the electronic device 310 generates virtual extended screen data based on the display information stored in the storage 313. In the case where the display information of a plurality of external display terminals 20 is stored in the storage 313, the controller 311 may generate a plurality of pieces of virtual extended screen data corresponding to the respective pieces of display information. The generated virtual extended screen data is transmitted to the external display terminal 20 via the relay device 30.

### [Effects]

According to the above embodiment, the following effects can be achieved.

The electronic device 310 has the storage 313 that stores display information related to at least one of the size or resolution of the display of the external display terminal 20. The controller 311 generates virtual extended screen data for the external display terminal 20 based on the display information stored in the storage 313.

Such a configuration enables the controller 311 to generate virtual extended screen data that matches the size or resolution of the display 21 of the external display terminal 20.

### Fourth Embodiment

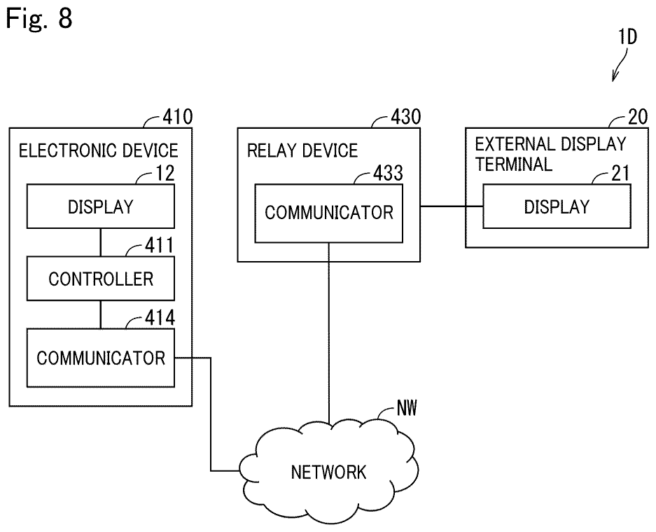

A fourth embodiment will be described with reference to FIG. 8. In the fourth embodiment, the same or equivalent components as those in the first embodiment will be denoted and described using the same reference numerals. In the fourth embodiment, descriptions overlapping with those in the first embodiment will be omitted.

FIG. 8 is a block diagram schematically showing a display control system 1D according to the fourth embodiment. As shown in FIG. 8, the fourth embodiment differs from the first embodiment in that a relay device 430 includes a communicator 433 connectable to a network NW. The fourth embodiment also differs from the first embodiment in that an electronic device 410 includes a communicator 414 and that a controller 411 of the electronic device 410 generates virtual extended screen data based on detection of a connection between the electronic device 410 and the network NW. In the fourth embodiment, the relay device 430 and the external display terminal 20 are directly connected by, for example, a cable. The other configurations of the display control system 1D are similar to those of the display control system 1 described in the first embodiment, and therefore description thereof will be omitted.

As shown in FIG. 8, the relay device 430 has the communicator 433 and is connected to the network NW by wire or wirelessly.

The communicator 433 includes a network interface circuit. The communicator 433 connects the relay device 430 to the network NW wirelessly or via a wire using a predetermined communication standard for a wide area network (WAN), a local area network (LAN), a mobile communication including a long-term evolution (LTE) and 5G, a power line communication, or a near-field communication including Bluetooth (registered trademark) and the like.

Similarly, in this embodiment, the electronic device 410 also has the communicator 414 that can be connected to the network NW by wire or wirelessly. Hence, the electronic device 410 and the relay device 430 can communicate with each other via the network NW. On the other hand, in this embodiment, the relay device 430 and the external display terminal 420 are connected without going through the network NW. The communicator 414 has the same configuration as the communicator 433.

The controller 411 of the electronic device 410 generates virtual extended screen data when triggered by detection of a connection between the electronic device 410 and the network NW via the communicator 414. The generated virtual extended screen data is received by the relay device 430 via the network NW.

### [Effects]

According to the above embodiment, the following effects can be achieved.

The relay device 430 has the communicator 433 that can be connected to the network NW by wire or wirelessly. The controller 411 generates virtual extended screen data based on the detection of the connection between the electronic device 410 and the network NW.

Such a configuration enables the controller 411 of the electronic device 410 to generate virtual extended screen data when triggered by the detection of a connection between the electronic device 410 and the network NW.

In the above embodiment, an example has been described where the relay device 430 and the external display terminal 20 are directly connected without going through the network NW, but this is not limitative.

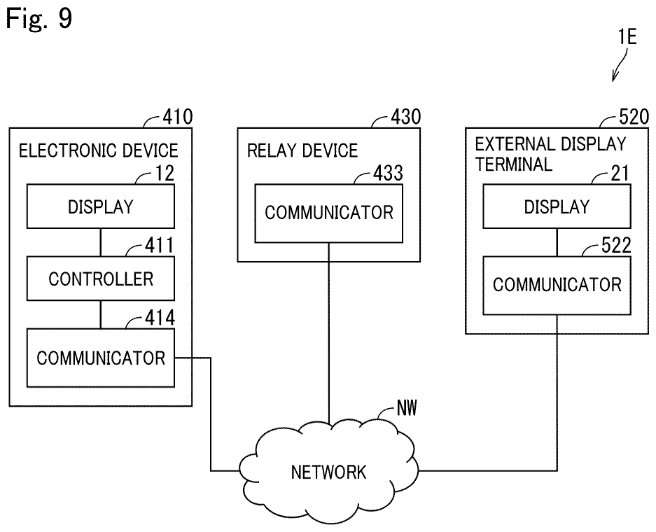

FIG. 9 is a block diagram schematically showing a display control system 1E according to a first variant of the fourth embodiment. As shown in FIG. 9, an external display terminal 520 includes a communicator 522, and the relay device 430 and the external display terminal 520 may be connected via a network NW. Since the electronic device 410, the relay device 430, and the external display terminal 520 are connected to the network NW via the respective communicators 414, 433, and 522, for example, even if the relay device 430 is installed at a location distant from the electronic device 410 and the external display terminal 520, the controller 411 can cause the external display terminal 520 to display a virtual extended screen based on the detection of a connection between the electronic device 410 and the network NW effected by the controller 411.

### Fifth Embodiment

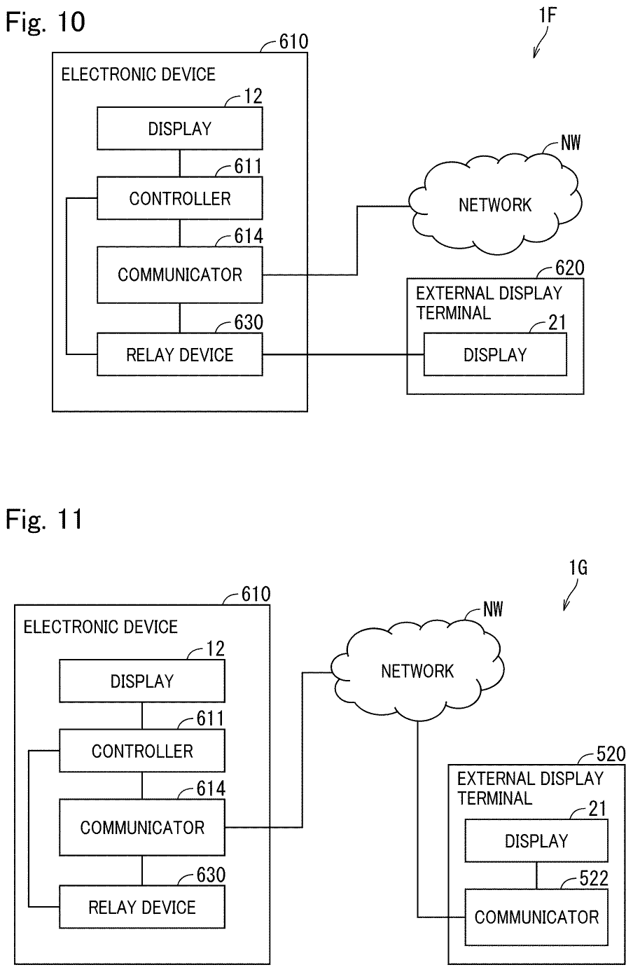

A fifth embodiment will be described with reference to FIG. 10. In the fifth embodiment, the same or equivalent components as those in the fourth embodiment will be denoted and described using the same reference numerals. In the fifth embodiment, descriptions overlapping with those in the fourth embodiment will be omitted.

FIG. 10 is a block diagram schematically showing a display control system 1F according to the fifth embodiment. As shown in FIG. 10, the fifth embodiment differs from the fourth embodiment in that an electronic device 610 has a built-in relay device 630. The fifth embodiment also differs from the fourth embodiment in that the relay device 630 is connected to the network NW via a communicator 614 of the electronic device 610. The other configurations of the display control system 1F are the same as those of the display control system 1D described in the fourth embodiment, and therefore description thereof will be omitted.

As shown in FIG. 10, in this embodiment, the relay device 630 is built into the electronic device 610. A controller 611 of the electronic device 610 generates virtual extended screen data based on detection of a connection between the electronic device 610 and the network NW via the communicator 614.

By incorporating the relay device 630 into the electronic device 610, the system configuration can be simplified.

FIG. 11 is a block diagram schematically showing a display control system 1G according to a first variant of the fifth embodiment. As shown in FIG. 11, the external display terminal 520 includes the communicator 522 and the configuration may be such that the external display terminal 520 is connectable to the network NW via the communicator 522. In this case, the relay device 630 and the external display terminal 520 are connected via the network NW.

### Additional Notes

The above description of the embodiments discloses the following techniques.

### Technique 1

A display control system including an electronic device having a controller that generates virtual extended screen data based on detection of a wired or wireless network or device connection; at least one external display terminals each having a display and displaying a virtual extended screen on the display based on the virtual extended screen data; and a relay device connected to the electronic device and the at least one external display terminals wirelessly or by wire, the relay device receiving the virtual extended screen data from the electronic device and transmitting the virtual extended screen data to the at least one external display terminals.

Such a configuration enables provision of a display control system that can extend the desktop screen based on a device or network connection.

### Technique 2

The display control system according to technique 1, wherein the electronic device has a storage that stores display information related to at least one of the size or resolution of the display of the at least one external display terminals, and wherein the controller generates the virtual extended screen data for the at least one external display terminals based on the display information stored in the storage.

Such a configuration enables the controller of the electronic device to generate virtual extended screen data that matches the size or resolution of the display of the external display terminal. This allows the external display terminal to display a virtual extended screen with a proper size or resolution.

### Technique 3

The display control system according to technique 1 or 2, wherein the relay device acquires, from the at least one external display terminals, display information related to at least one of the size and or resolution of the display of the at least one external display terminals, and wherein the relay device modifies the virtual extended screen data based on the display information and transmits the modified data to the at least one external display terminals.

Such a configuration enables the relay device to modify the extended screen data generated by the controller of the electronic device to match the size or resolution of the external display terminal. This allows the external display terminal to display a virtual extended screen with a proper size or resolution.

### Technique 4

The display control system according to any one of techniques 1 to 3, wherein the relay device is connected to a cradle connectable to the electronic device, and wherein the controller generates the virtual extended screen data based on detection of a connection between the electronic device and the cradle.

Such a configuration enables virtual extended screen data to be generated in response to the detection of a connection between the electronic device and the cradle. Thus, for example, the generation of virtual extended screen data can be triggered by the detection of a connection of the electronic device to the cradle inside a vehicle, and the virtual extended screen can also be displayed on the display of the car navigation system.

### Technique 5

The display control system according to any one of techniques 1 to 4, wherein the relay device has a communicator that is connectable to a network by wire or wirelessly, and wherein the controller generates the virtual extended screen data based on detection of a connection between the electronic device and a network.

Such a configuration enables the controller to generate virtual extended screen data based on the detection of a connection between the electronic device and the network.

### Technique 6

The display control system according to any one of techniques 1 to 5, wherein the external display terminal includes at least one of a car navigation system, a tablet device, or a smartphone.

Such a configuration enables an electronic device that is not normally used as an external display to be used as an external display.

### Technique 7

The display control system according to any one of techniques 1 to 6, wherein the relay device is built into the electronic device.

Such a configuration can simplify the display control system.

The present disclosure is widely applicable to a system including an electronic device such as a laptop PC.

What is claimed is

1. A display control system comprising:
an electronic device having a controller that generates virtual extended screen data based on detection of a wired or wireless network or device connection;
at least one external display terminals each having a display and displaying virtual extended screen on the display based on the virtual extended screen data; and
a relay device connected to the electronic device and the at least one external display terminals wirelessly or by wire, the relay device receiving the virtual extended screen data from the electronic device and transmitting the virtual extended screen data to the at least one external display terminals,
wherein the relay device acquires, from the at least one external display terminals, display information related to at least one of a size or resolution of the display of the at least one external display terminals, and wherein
the relay device modifies the virtual extended screen data based on the display information and transmits the modified data to the at least one external display terminals.

2. The display control system according to claim 1, wherein
the electronic device has a storage that stores the display information related to at least one of the size or resolution of the display of the at least one external display terminals, and wherein
the controller generates the virtual extended screen data for the at least one external display terminals based on the display information stored in the storage.

3. The display control system according to claim 1, wherein
the relay device is connected to a cradle connectable to the electronic device, and wherein
the controller generates the virtual extended screen data based on detection of a connection between the electronic device and the cradle.

4. The display control system according to claim 1, wherein
the relay device has a communicator that is connectable to a network by wire or wirelessly, and wherein
the controller generates the virtual extended screen data based on detection of a connection between the electronic device and a network.

5. The display control system according to claim 1, wherein
the external display terminal includes at least one of a car navigation system, a tablet device, or a smartphone.

6. The display control system according to claim 1, wherein
the relay device is built into the electronic device.

7. The display control system according to claim 2, wherein
the relay device is connected to a cradle connectable to the electronic device, and wherein
the controller generates the virtual extended screen data based on detection of a connection between the electronic device and the cradle.

8. The display control system according to claim 2, wherein
the relay device has a communicator that is connectable to a network by wire or wirelessly, and wherein
the controller generates the virtual extended screen data based on detection of a connection between the electronic device and a network.

9. The display control system according to claim 3, wherein
the relay device has a communicator that is connectable to a network by wire or wirelessly, and wherein
the controller generates the virtual extended screen data based on detection of a connection between the electronic device and a network.

10. The display control system according to claim 2, wherein
the external display terminal includes at least one of a car navigation system, a tablet device, or a smartphone.

11. The display control system according to claim 3, wherein
the external display terminal includes at least one of a car navigation system, a tablet device, or a smartphone.

12. The display control system according to claim 4, wherein
the external display terminal includes at least one of a car navigation system, a tablet device, or a smartphone.

13. The display control system according to claim 2, wherein
the relay device is built into the electronic device.

14. The display control system according to claim 3, wherein
the relay device is built into the electronic device.

15. The display control system according to claim 4, wherein
the relay device is built into the electronic device.

16. The display control system according to claim 5, wherein
the relay device is built into the electronic device.
